(19) United States
(12) Patent Application Publication
(10) Pub. No.: US 2019/0100929 A1
(43) Pub. Date: Apr. 4, 2019

(54) HOIST SYSTEM WITH DIRECT CURRENT POWER SUPPLY

(71) Applicant: SafeWorks, LLC, Tukwila, WA (US)

(72) Inventors: Vishnu Irigireddy, Renton, WA (US); Helen Gong, Renton, WA (US)

(21) Appl. No.: 16/145,961

(22) Filed: Sep. 28, 2018

Related U.S. Application Data
(60) Provisional application No. 62/565,581, filed on Sep. 29, 2017.

(51) Int. Cl. E04G 3/32; H02P 7/06; H02P 27/06; H02J 7/00; E04G 5/00

(52) U.S. Cl. CPC E04G 3/32; H02P 7/06; E04G 2003/286; H02J 7/0068; E04G 5/00; H02P 27/06

(57) ABSTRACT

A hoist system includes a motor with a drive shaft connected to a traction sheave, traction drum, or pinion. The hoist system further includes a compartment configured to at least partially enclose a direct current power supply such that the direct current power supply is electrically connected to the motor. The motor is configured to receive an input and convert the input to movement of the drive shaft as an output, and the motor is configured to be coupled to a load such that movement of the drive shaft moves the load.

### CROSS-REFERENCE

This application claims benefit under 35 U.S.C. § 119(e) of Provisional U.S. patent application No. 62/565,581, filed Sep. 29, 2017, the contents of which are incorporated herein by reference in their entirety.

### TECHNICAL FIELD

The present disclosure relates generally to systems, devices, and methods configured to assist raising and lowering of loads. More specifically, the present disclosure relates to systems, devices, and methods of raising and lowering loads including a direct current power supply.

### BACKGROUND

Hoist devices are known, such as U.S. Pat. No. 7,849,971. Known hoist devices, such as the one disclosed in U.S. Pat. No. 7,849,971, include a motor that is in electrical communication with an alternating current power source. Connection with an alternating current power source may restrict deployment of known hoist devices to locations with an available alternating current power supply. Additionally, connection with an alternating current power supply may restrict portability of known hoist devices, as the known hoist device may include an electrical cord that needs to be plugged in to the alternating power supply to supply power to the motor.

A hoist system configured to operate when connected to a direct current power supply may result in a hoist system that is deployable in more locations than a traditional hoist system, for example locations without an available power source. Additionally, a hoist system configured to operate when connected to a direct current power supply may result in a hoist system that is more portable than a traditional hoist system.

### SUMMARY

According to an aspect of the disclosure, a hoist system includes a motor including a drive shaft. The hoist system further includes a compartment configured to at least partially enclose a direct current power supply such that the direct current power supply is electrically connected to the motor. The motor is configured to receive an input and convert the input to movement of the drive shaft as an output, and the motor is configured to be coupled to a load such that movement of the drive shaft moves the load.

According to an aspect of the disclosure, a method of moving a load includes the steps of inserting a direct current power supply into a compartment such that the direct current power supply is electrically coupled to a motor, and actuating a control mechanism thereby signaling the motor to move or stop the load.

### BRIEF DESCRIPTION OF THE DRAWINGS

The foregoing summary, as well as the following detailed description of illustrative embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a side elevation view of a hoist system, according to one aspect of the disclosure;

FIG. 2 is a side elevation view of a motor of the hoist system illustrated in FIG. 1;

FIG. 3 is a flow diagram for the hoist system illustrated in FIG. 1, according to one embodiment;

FIG. 4 is a flow diagram for the hoist system illustrated in FIG. 1, according to another embodiment;

FIG. 5 is a flow diagram for the hoist system illustrated in FIG. 1, according to another embodiment; and

FIG. 6 is a flow diagram for the hoist system illustrated in FIG. 1, according to another embodiment.

### DETAILED DESCRIPTION OF ILLUSTRATIVE EMBODIMENTS

The embodiments disclosed herein are not limited in application to the details of construction and the arrangement of components set forth in the following description or illustrated in the drawings. The disclosure is capable of other embodiments and of being practiced or being carried out in various ways. In addition, the phraseology and terminology used herein is for the purpose of description and should not be regarded as limiting.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. Certain features of the disclosure, which are described herein in the context of separate embodiments, may also be provided in combination in a single embodiment. Conversely, various features of the disclosure that are described in the context of a single embodiment may also be provided separately or in any subcombination.

Hoists are used in a variety of applications such as construction, repair and maintenance of buildings and other structures, etc. Two general varieties of hoists include personnel hoists and material hoists. A personnel hoist is designed to lift and lower one or more persons, and a material hoist is designed to lift and lower material. Each of the varieties of hoist may use a suspended path medium. A suspended path medium typically is a wire rope, but may be made of other materials such as synthetic rope or chain. Wire rope is the most common type of suspended path media.

Personnel hoists are typically used to connect a platform or other suspended body to a fixture above. Personnel hoists, by means of a mechanical drive mechanism, lift or lower a platform between ground level and the fixture above. The platform can be used to support a load, such as one or more persons according to one example. Personnel hoists may be powered by electric, pneumatic, hydraulic, or other powered means. Personnel hoists may operate via traction sheave principle to pull the platform. A personnel hoist may also operate by a drum wrap principle to tension and pull the wire rope.

Material hoists are used by attaching the material hoist to an overhead fixture and lowering a wire rope to a level below. The material hoist is used to lift a material load typically with a wire rope. The material hoists are powered similarly to the personnel hoists, e.g., by electric, pneumatic, hydraulic, or other powered means. The material hoists may also use either a traction sheave or drum wrap principle to tension/pull the wire rope.

Personnel hoists may include an attachment point to connect the hoist to the platform such that the wire rope is directed upward from the platform to connect to a fixture above the platform. Material hoists may have an attachment point to connect the hoist to a fixture such that the wire rope is directed downward to connect to a material load below.

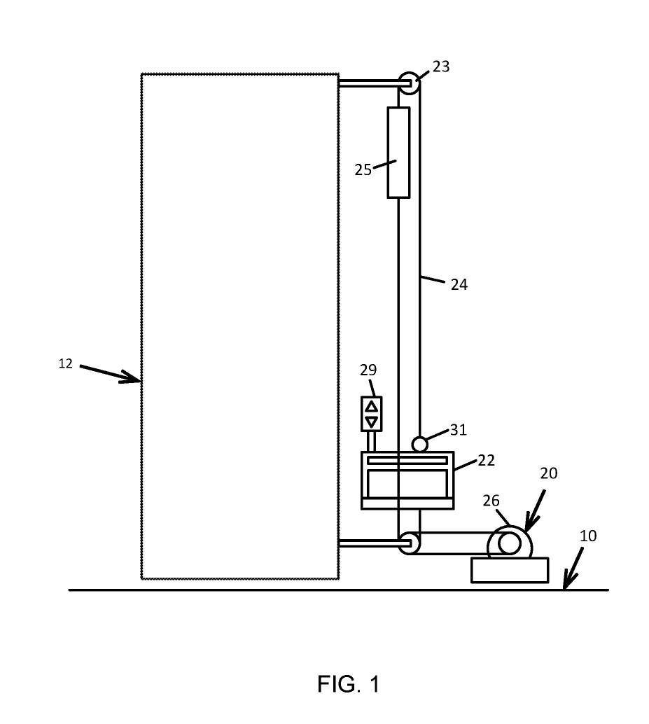

Referring to FIG. 1, a hoist system 20, (hereinafter the system 20) is configured to lift and lower loads. Examples of types of the system 20 include, but are not limited to, traction hoists and rack and pinion hoists. As shown in the illustrated embodiment, the hoist system 20 may be deployed at a location 10, such as a building 12. The system 20 includes a platform 22, one or more cables 24 (hereinafter the cable 24), and a motor 26. The platform 22 is configured to support the load while the load is lifted and lowered. The cable 24 is attached to the platform 22 such that movement of the cable 24 results in movement of the platform 22. The motor 26 is coupled to the cable 24 such that motor 26 is capable of moving the cable 24.

According to one aspect of the disclosure, the system 20 is configured to lift industrial loads. The cable 24 may be configured to lift loads heavier than one person. Thus cable 24 may be stronger than a synthetic rope. The cable 24 may include, for example, a steel wire.

According to one aspect of the disclosure, the system 20 may include a pulley 23 and a counterweight 25. One end of the cable 24 may be attached to the platform 22, the other end of the cable 24 may be attached to the counterweight 25, and a portion of the cable 24 between the ends is in contact with the pulley 23. The counterweight 25 lowers the amount of force needed to lift and lower the platform 22 and the load. According to one aspect of the disclosure, the system 20 may include a rack and pinion assembly coupled to the motor 26 and the platform 22. According to one aspect of the disclosure, the system 20 may include a chain drive assembly rack and pinion system coupled to the motor 26 and the platform 22.

The system 20 may further include a control mechanism 29 that is configured to receive an input from a user. The control mechanism 29 is configured to send a signal to the motor 26 to move the load in a direction that corresponds to the input from the user. For example, the control mechanism may include a plurality of buttons, including a first button configured to send a signal to the motor to raise the load, a second button configured to send a signal to the motor to lower the load, and a third button to configured to send a signal to the motor to stop movement of the load. The control mechanism 29 may be mounted on the platform 22, the motor 26, the building 12, or none of the above. The control mechanism 29 may be wired to the motor 26, or wirelessly connected to the motor 26. The system 20 may further include an overspeed safety mechanism 31, which is configured to slow or stop the platform 22 from lowering, in the event that the platform 22 reaches a predetermined ascent or descent speed.

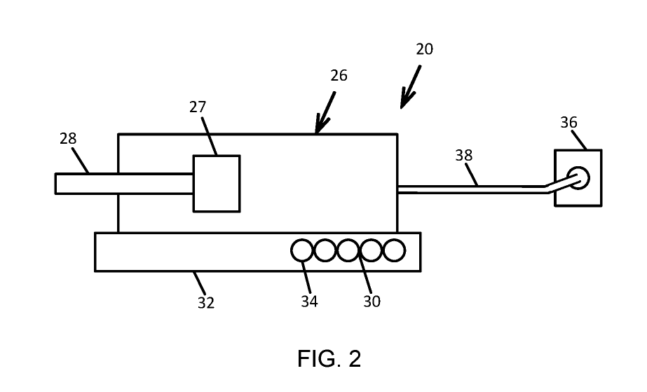

Referring to FIG. 2, the motor 26 is configured to receive an input and convert the input into an output. According to one aspect of the disclosure, the motor 26 is configured to receive power as an input, and convert the power into movement. As shown in the illustrated embodiment, the system 20 includes a motor drive 27, and the motor 26 includes a drive shaft 28. The motor 26 is configured to convert the power input into rotational movement of the drive shaft 28. The motor drive 27 may be configured to control characteristics of the rotational movement of the drive shaft 28. The characteristics may include, but are not limited to, speed, torque, direction, and any combination thereof.

According to one aspect of the disclosure, the motor 26 is configured to convert direct current (hereinafter DC) from a DC power supply 30 into the output. The system 20 may include the DC power supply 30. Alternatively, the DC power supply 30 may be separate from the system 20. The system 20 may be configured such that the DC power supply 30 is positioned close to the motor 26. The system 20 may include a compartment 32 configured to at least partially enclose the DC power supply 30. As shown in the illustrated embodiment, the motor 26 may include the compartment 32. Positioning the DC power supply 30 close to the motor 26 may allow the system 20 to operate while devoid of any external electrical connectors, such as a power cord. The lack of an external electrical connector may prevent tripping near the motor, and may also increase the locations at which the system 20 is suitable to be deployed and operated, as an existing, external power source may not be needed.

The DC power supply 30 may include a battery bank 34, which includes one or more batteries. The DC power supply 30 may be removable, rechargeable, or both. The DC power supply 30 may be installed on the platform 22, for example on rails on a bottom side of the platform 22, or on vertical rails of the platform 22. The DC power supply 30 may be installed in one location, or in multiple locations.

According to one aspect of the disclosure, the motor 26 is configured to convert alternating current (hereinafter AC) from an AC power supply 36, DC from a DC power supply 30, or both into the output. As shown in the illustrated embodiment, the motor 26 may include a connector 38 configured to connect the motor to the AC power supply 36.

The motor 26 may be configured to operate in electric, pneumatic, and hydraulic applications.

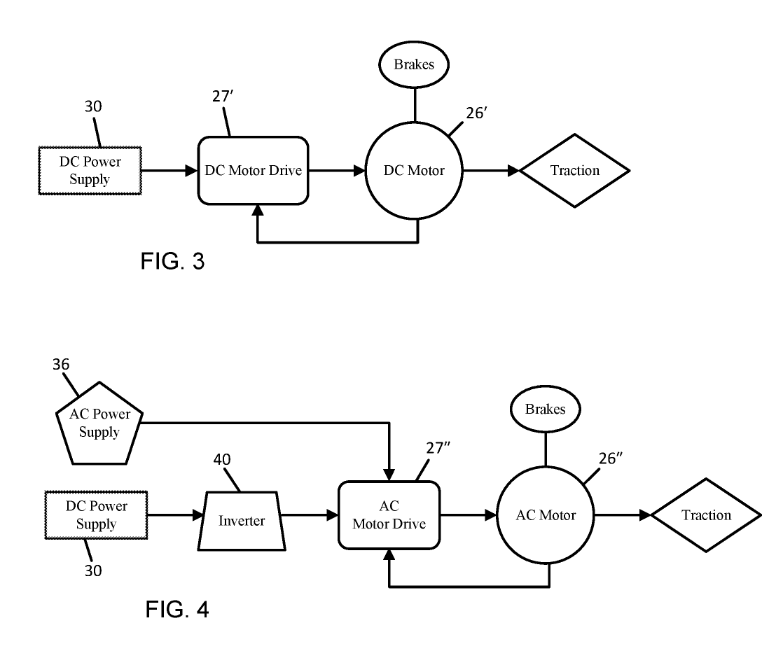

Referring to FIGS. 2 and 3, according to one aspect of the disclosure, the motor drive 27 is a DC motor drive 27′ configured to accept DC from the DC power supply 30, and the motor 26 is a DC motor 26′. Use of the DC power supply 30 and the DC motor drive 27′ may result in better performance, for example faster start and stop times, better controls, etc., when compared to an AC motor drive.

The DC is supplied from the DC power supply 30 to the DC motor drive 27′, and the DC motor drive 27′ signals the DC motor 26′ to control the output, for example the speed, direction, and torque of the drive shaft 28. The DC motor 26′ upon receiving a corresponding signal from the DC motor drive 27′, may apply traction or brakes to the drive shaft 28.

Referring to FIGS. 2 and 4, according to one aspect of the disclosure, the motor drive 27 is an AC motor drive 27″ configured to accept AC from the AC power supply 30, and the motor 26 is an AC motor 26″. The motor 26 may further be configured to accept DC from the DC power supply 30. The system 20 may include an inverter 40 that receives the DC, converts the DC to AC, and outputs the AC to the AC motor drive 27″.

The AC is supplied from the AC power supply 36, the inverter 40, or both, to the AC motor drive 27″, and the AC motor drive 27″ signals the AC motor 26″ to control the output, for example the speed, direction, and torque of the drive shaft 28. The AC motor 26″, upon receiving a corresponding signal from the AC motor drive 27″, may apply traction or brakes to the drive shaft 28.

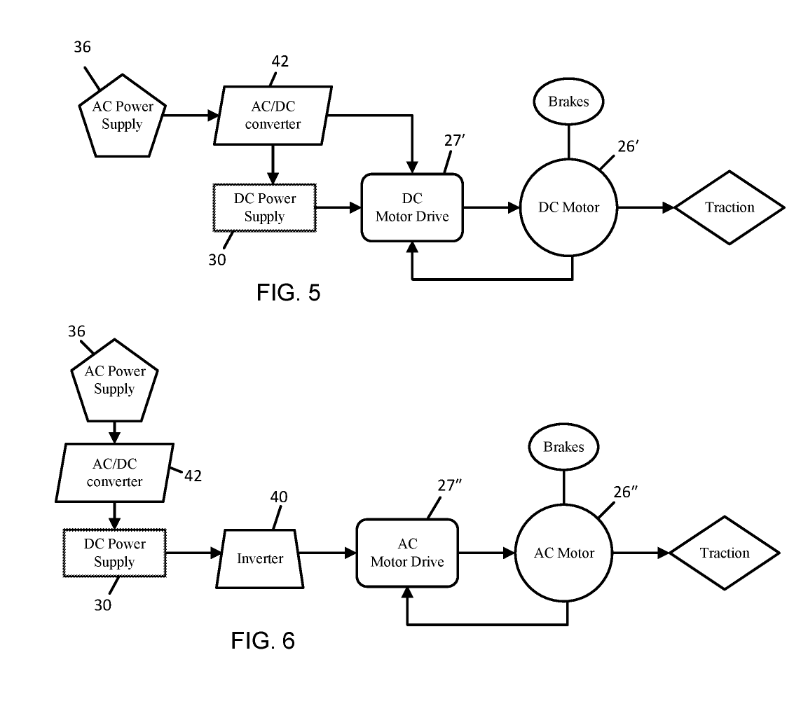

Referring to FIGS. 2 and 5, the system 20 may include the DC motor drive 27′ and the DC motor 26′. The system 20 may include an alternating current to direct current converter 42 (hereinafter AC/DC converter 42) that receives the AC from the AC power supply 36, converts the AC to DC, and outputs the DC to either the DC motor drive 27′, the DC power supply 30, or both, for example selectively.

The DC is supplied from the DC power supply 30, the converter 42, or both, to the DC motor drive 27′, and the DC motor drive 27′ signals the DC motor 26′ to control the output, for example the speed, direction, and torque of the drive shaft 28. The DC motor 26′, upon receiving a corresponding signal from the DC motor drive 27′, may apply traction or brakes to the drive shaft 28.

Referring to FIGS. 2 and 6, the system 20 may include the AC motor drive 27″ and the DC motor 26″. The system 20 may include a converter 42 that receives the AC from the AC power supply 36, converts the AC to DC, and outputs the DC to the DC power supply 30. The system 20, according to one embodiment, includes the inverter 40, which receives the DC from the DC power supply 30, converts the DC to AC, and outputs the AC to the AC motor drive 27″.

The AC is supplied from the AC power supply 36, the inverter 40, or both, to the AC motor drive 27″, and the AC motor drive 27″ signals the AC motor 26″ to control the output, for example the speed, direction, and torque of the drive shaft 28. The AC motor 26″, upon receiving a corresponding signal from the AC motor drive 27″, may apply traction or brakes to the drive shaft 28.

Referring to FIGS. 1 to 6, the system 20 may be configured to charge the DC power supply 30 when the motor 26 is not lifting the platform 22, for example when the platform 22 is lowering, or when the platform 22 is coming to a stop. The system 20 may be configured to include multiple DC power supplies 30, for example a plurality of battery banks. The system 20 may be configured such that: the multiple DC power supplies 30 are chained together to provide additional capacity; individual ones of the multiple DC power supplies 30 are able to be “hot swapped” or removed and replaced with a more fully charged DC power supply during a lifting/lowering operation of the platform 22.

It will be appreciated that the foregoing description provides examples of the disclosed system. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein. All methods described herein can be performed in any suitable order unless otherwise indicated herein or otherwise clearly contradicted by context.

Although the disclosure has been described in detail, it should be understood that various changes, substitutions, and alterations could be made herein without departing from the spirit and scope of the invention as defined by the appended claims. Moreover, the scope of the present disclosure is not intended to be limited to the particular embodiments described in the specification. As one of ordinary skill in the art will readily appreciate from the disclosure of the present invention, processes, machines, manufacture, composition of matter, means, methods, or steps, presently existing or later to be developed that perform substantially the same function or achieve substantially the same result as the corresponding embodiments described herein may be utilized according to the present disclosure.

What is claimed:

1. A method of changing an elevation of a load, the method comprising the steps of:
electrically coupling a direct current power supply to a motor of a hoist system;
coupling an output shaft of the motor to a rotatable member of the hoist system such that rotation of the output shaft rotates the rotatable member, wherein the rotatable member is one of a traction sheave, a traction drum, or a pinion of a rack and pinion system;
coupling the rotatable member to the load such that: 1) rotation of rotatable member in a first direction increases the elevation of the load, and 2) rotation of the rotatable member in a second direction, which is opposite the first direction, decreases the elevation of the load;
supplying power from the direct current power supply to the motor thereby: 1) rotating the output shaft; 2) rotating the rotatable member; and 3) changing the elevation of the load.

2. The method of claim 1, wherein the motor is a direct current motor, and the supplying step includes the step of supplying direct current from the direct current power supply to the direct current motor.

3. The method of claim 1, wherein the motor is an alternating current motor, and the supplying step includes the steps of:
converting direct current from the direct current power supply into alternating current; and
supplying the alternating current to the alternating current motor.

4. The method of claim 1, further comprising the step of coupling the direct current power supply to the load such that the step of changing the elevation of the load also changes the elevation of the direct current power supply.

5. The method of claim 4, wherein the step of coupling the direct current power supply to the load includes the steps of:
coupling a first portion of the direct current power supply to a first location; and
coupling a second portion of the direct current power supply to a second location, which is remote from the first location.

6. The method of claim 5, wherein the step of coupling a first portion of the direct current power supply includes the step of inserting a first battery into a first compartment that at least partially encloses the first battery.

7. The method of claim 6, wherein the step of coupling a second portion of the direct current power supply includes the step of inserting a second battery into a second compartment that at least partially encloses the second battery.

8. The method of claim 7, further comprising the steps of:
removing the first battery from the first compartment thereby electrically decoupling the first battery from the motor; and
after the removing step, inserting a third battery into the first compartment thereby electrically coupling the third battery to the motor.

9. The method of claim 8, wherein the step of supplying power from the direct current power supply to the motor is performed after the step of removing the first battery and before the step of inserting the third battery.

10. The method of claim 1, further comprising the step of applying a braking force to slow rotation of the rotatable member.

11. The method of claim 10, further comprising the step of charging the direct current power supply.

12. The method of claim 11, wherein the charging step occurs during the applying step.

13. The method of claim 11, wherein the charging step occurs during rotation of the rotatable member in the second direction and decreasing the elevation of the load.

14. A hoist system configured to change an elevation of a load, the hoist system comprising:
a direct current power supply;
a motor including an output shaft, the motor electrically coupled to the direct current power supply;
a rotatable member coupled to the output shaft such that rotation of the output shaft rotates the rotatable member, wherein the rotatable member is one of a traction sheave, a traction drum, or a pinion of a rack and pinion system;
a platform configured to support the load during the change in elevation of the load, the platform coupled to the rotatable member such that: 1) rotation of rotatable member in a first direction increases the elevation of the platform, and 2) rotation of the rotatable member in a second direction, which is opposite the first direction, decreases the elevation of the platform.

15. The system of claim 14, wherein the motor is a direct current motor, and the direct current motor is electrically coupled to the direct current power supply such that direct current from the direct current power supply is supplied directly to the direct current motor.

16. The system of claim 14, wherein the motor is an alternating current motor, and the system further comprises a converter electrically coupled to both the direct current power supply and the alternating current motor such that the converter is configured to accept direct current from the direct current power supply, convert the direct current to alternating current, and send the alternating current to the alternating current motor.

17. The system of claim 14, wherein the direct current power supply is supported by the platform such that the elevation of the direct current power supply changes as the elevation of the platform changes.

18. The system of claim 17, wherein the direct current power supply includes a first portion supported by the platform at a first location, and the direct current power supply includes a second portion supported by the platform at a second location, the second location remote from the first location.

19. The system of claim 18, wherein the platform includes a floor and a wall, the wall oriented 90 degrees from the floor, the first location is on the wall, and the second location is on the floor.
